(19) United States
(12) Patent Application Publication
(10) Pub. No.: US 2012/0058337 A1
(43) Pub. Date: Mar. 8, 2012

(54) CARBON FIBER AND METHOD FOR PRODUCING THE SAME

(75) Inventors: Hiroshi Sakurai, Iwakuni-shi (JP); Hiroshi Hara, Iwakuni-shi (JP); Shoichi Takagi, Iwakuni-shi (JP)

(73) Assignee: TEIJIN LIMITED, Osaka-shi, Osaka (JP)

(21) Appl. No.: 13/140,711

(22) PCT Filed: Dec. 17, 2009
(86) PCT No.: PCT/JP09/71508

§ 371 Date: Jun. 17, 2011

(30) Foreign Application Priority Data
Dec. 19, 2008 (JP) 2008-323895

(51) Int. Cl. D02G 3/00; C01B 31/10

(52) U.S. Cl. 428/364; 264/29.6

(57) ABSTRACT

An object of the present invention is to provide a pitch carbon fiber having a decreased occurrence of cracking along the direction of the fiber axis of the pitch carbon fiber, which has conventionally occurred in a melt blowing method, and having high thermal conductivity.

The invention is directed to a pitch carbon fiber having a melt mark recognized in the fiber corresponding to 60 to less than 100% of the cross-section of the fiber, and having a lattice spacing (d 002 value) of 0.3362 nm or less in the graphite layer and a crystallite size (Lc) of 60 nm or more derived from the thicknesswise direction, as determined by X-ray diffractometry. The pitch carbon fiber can be produced under specific conditions for spinning and infusibilization.

### TECHNICAL FIELD

The present invention relates to a pitch carbon fiber which can be advantageously used as a thermal managing material or a reinforcement for resin, and a method for producing the pitch carbon fiber. More particularly, there can be provided a pitch carbon fiber produced by a melt blowing method under specific spinning conditions wherein the pitch carbon fiber has a remarkably decreased occurrence of cracking along the direction of the fiber axis of the pitch carbon fiber as well as high graphitizability, as compared to conventional pitch carbon fibers produced by a melt blowing method.

### BACKGROUND ART

Carbon fiber comprising mesophase pitch as a raw material has excellent graphitizability and hence can achieve high modulus. However, in the spinning step for forming fiber, polycyclic aromatic molecules constituting the pitch are arranged in the direction perpendicular to the flow direction of the pitch passing through a spinning pore, so that the resultant carbon fiber disadvantageously exhibits a radial structure. In the fiber of a radial structure, a stress strain (cracking) is likely to be caused due to the shrinkage between molecular planes during the calcination step, so that microdefects are caused in the fiber, leading to a marked lowering of the physical properties of the fiber.

As a method for solving the above problem, there has been proposed a method for producing a carbon fiber having a cross-section of the fiber which is substantially elliptic, and having a lamellar arrangement in a leaf-like form in which a number of lamellas symmetrically extends toward both sides from the center axis of the cross-section of the fiber at an angle of 15 to 90° (patent documents 1 and 2). In addition, there has also been proposed a method for producing a carbon fiber, in which the molten pitch to be fed to a spinning pore is preliminarily rectified so that the stress strain in the direction of the fiber cross-section is smoothly relaxed (patent document 3). However, all of the above patent documents relate to a method for producing a continuous fiber, and pose problems in that the production cost for the fiber is high, as compared to that for a carbon fiber produced by a melt blowing method, that a special spinning infrastructure is needed and hence the facilities cost much, and the like. Further, the carbon fibers produced by the methods described in these patent documents have a lamellar arrangement clearly observed, which is a structure comprising an aggregate of a great number of small crystals (domains). For this reason, such carbon fibers have a problem in that heat as a resistance is caused at the joints between the crystals and hence the fiber is unlikely to exhibit large thermal conduction.

On the other hand, in a melt blowing method which can produce a carbon fiber at a low cost, like the methods described in the above-mentioned patent documents, pitch molecules are arranged in the direction perpendicular to the flow direction of the pitch. However, air at a high temperature is sprayed to both sides of the pitch expanded due to a Barus effect near the spinning pore, and therefore it is believed that the resultant fiber has a cross-section of a symmetrical structure with respect to the line and does not exhibit a radial structure (non-patent document 1). However, even the carbon fiber produced by a melt blowing method has a problem in that when a stress is applied to the fiber, a stress strain (cracking) is likely to be caused along the axis of line symmetry of the cross-section of the fiber, so that microdefects are caused in the fiber, leading to a marked lowering of the physical properties of the fiber. Further, also in this document, a lamellar arrangement is clearly observed, and a problem is encountered in that heat as a resistance is caused at the joints between the crystals and hence the fiber is unlikely to exhibit large thermal conduction.

In this situation, the present inventors have proposed a carbon fiber having excellent mechanical properties and thermal managing properties, which is achieved by controlling the spinning conditions in a melt blowing method, such as the melt viscosity, the flow rate of the mesophase pitch in a capillary, or the adsorption of oxygen on the infusibilized carbon fiber precursor.
(Patent document 1) JP-A-61-113828
(Patent document 2) JP-A-61-6314
(Patent document 3) JP-A-61-113827
(Patent document 4) JP-A-2009-019309
(Non-patent document 1) Carbon 38 (2000) P741-747

### DISCLOSURE OF THE INVENTION

An object of the present invention is to provide a pitch carbon fiber having a remarkably decreased occurrence of cracking along the direction of the fiber axis of the pitch carbon fiber as well as high graphitizability and high thermal conductivity, as compared to conventional pitch carbon fibers produced by a melt blowing method.

### Means for Solving the Problems

The pitch carbon fiber of the invention is a pitch carbon fiber having a melt mark recognized in the fiber corresponding to 60 to less than 100% of the cross-section of the fiber, and having a lattice spacing (d 002 value) of 0.3362 nm or less in the graphite layer and a crystallite size (Lc) of 60 nm or more derived from the thicknesswise direction, as determined by X-ray diffractometry.

In the invention, the pitch carbon fiber has a melt mark in the fiber corresponding to 60 to less than 100% of the cross-section of the fiber, and therefore has a decreased occurrence of cracking along the direction of the fiber axis of the pitch carbon fiber, which has conventionally occurred in a melt blowing method, and further has a reduced lattice spacing (d 002 value) in the graphite layer and an increased crystallite size (Lc) derived from the thicknesswise direction, as determined by X-ray diffractometry, thus achieving high thermal conductivity.

The pitch carbon fiber of the invention can be preferably obtained by a method for producing the pitch carbon fiber, which comprises (1) a step for preparing a pitch carbon fiber precursor from mesophase pitch by a melt blowing method, (2) a step for infusibilizing the pitch carbon fiber precursor in an oxidizing gas atmosphere to prepare a pitch infusibilized fiber, and (3) a step for calcining the infusibilized fiber to produce a pitch carbon fiber, wherein the method is characterized in that, in step (1) for preparing a pitch carbon fiber precursor, the melt viscosity in a spinning pore is more than 1.0 to less than 10 Pa·s (more than 10 to less than 100 poises), the mesophase pitch passing through the spinning pore has a shear rate of more than 6,000 to less than 15,000 s⁻¹, and a gas at 4,000 to 12,000 m/minute, which is heated to a temperature that is the temperature ±20° C. of the pitch passing through the spinning pore, is sprayed to the mesophase pitch near the spinning pore, and is characterized in that, in step (2) for preparing a pitch infusibilized fiber, the amount of oxygen deposited onto the pitch infusibilized fiber is 5.5 to 7.5 wt %.

### Advantage of the Invention

The pitch carbon fiber of the invention has a remarkably decreased occurrence of cracking along the direction of the fiber axis of the pitch carbon fiber and further has high graphitizability and high thermal conductivity, as compared to conventional pitch carbon fibers produced by a melt blowing method. Therefore, the pitch carbon fiber of the invention can be advantageously used in the application of an agent for imparting high thermal conductivity as well as the application of a reinforcement for resin. Further, the pitch carbon fiber of the invention preferably has an elliptic cross-section, and when producing a composite of the pitch carbon fiber with a resin, the efficiency of packing of the pitch carbon fiber is improved, and thus the packing properties are improved. A characteristic feature of the invention also resides in that the pitch carbon fiber having a cross-section in such an irregular form can be produced without using a particular nozzle of an irregular shape.

### BRIEF DESCRIPTION OF THE DRAWINGS

FIG. 1 is a scanning electron photomicrograph of the cross-section of the pitch carbon fiber in Example 1.

FIG. 2 is a scanning electron photomicrograph of the cross-section of the pitch carbon fiber in Example 6.

FIG. 3 is a scanning electron photomicrograph of the cross-section of the pitch carbon fiber in Comparative Example 1.

FIG. 4 is a scanning electron photomicrograph of the cross-section of the pitch carbon fiber in Comparative Example 3.

FIG. 5 is a scanning electron photomicrograph of the cross-section of the pitch carbon fiber in Comparative Example 5.

FIG. 6 is a photograph for observing the occurrence of cracking in the surface of the pitch carbon fiber in Comparative Example 1.

### BEST MODE FOR CARRYING OUT THE INVENTION

Hereinbelow, the present invention will be described in detail.

The pitch carbon fiber of the invention has a melt mark recognized in the fiber corresponding to 60 to less than 100% of the cross-section of the fiber, and has a lattice spacing (d 002 value) of 0.3362 nm or less in the graphite layer and a crystallite size (Lc) of 60 nm or more derived from the thicknesswise direction, as determined by X-ray diffractometry. The pitch carbon fiber of the invention is a pitch carbon fiber having a decreased occurrence of cracking along the direction of the fiber axis of the pitch carbon fiber and having high thermal conductivity, as compared to conventional pitch carbon fibers produced by a melt blowing method.

One of the characteristic features of the pitch carbon fiber of the invention resides in that a melt mark is recognized in the fiber corresponding to 60 to less than 100% of the cross-section of the fiber. In the invention, the pitch carbon fiber has a melt mark in the fiber corresponding to 60 to less than 100% of the cross-section of the fiber, and therefore has a decreased occurrence of cracking along the direction of the fiber axis of the pitch carbon fiber, which has conventionally occurred in a melt blowing method, and further achieves high thermal conductivity.

The melt mark indicates an indefinite-form mass of crystals formed from the pitch as a raw material which is molten within the cross-section of fiber during the infusibilization or carbonization. The melt mark is observed as one indefinite-form mass when a cross-sectional image of the fiber is taken by means of a scanning electron microscope at a magnification of 3,000 to 7,000, wherein in the mass of the molten carbon fiber, layers of carbon crystals in the form of a long streak are observed.

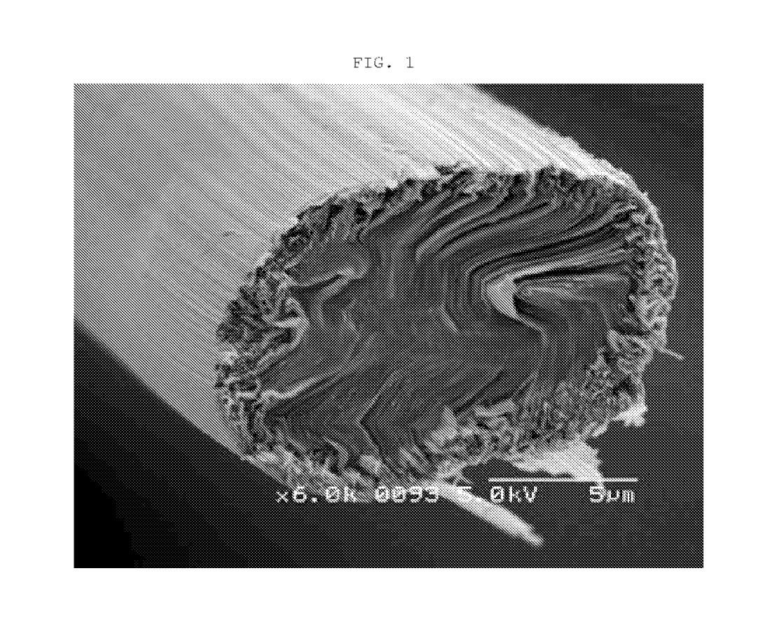

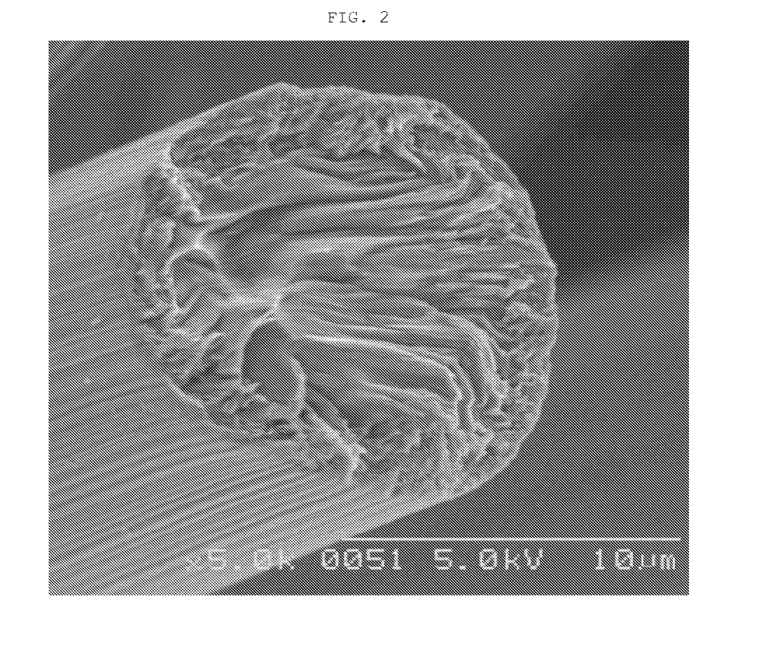

Examples of photographs of the cross-sections of the carbon fiber of the invention are shown in FIGS. 1 and 2, which show that in the melt mark, layers of carbon crystals in the form of a streak extend in a zigzag direction across the middle portion of the cross-section. It is apparent that the cross-section of the carbon fiber of the invention is different from the cross-section of a non-oriented glassy structure as seen in isotropic pitch, a random structure, or a radial structure.

When the melt mark occupies less than 60% of the cross-section of the fiber, a lamellar arrangement comprising an aggregate of a great number of small crystals (domains) is observed in the fiber, and heat as a resistance is caused at the joints between the crystals, so that the fiber is disadvantageously unlikely to exhibit large thermal conduction.

The larger the ratio of the melt mark occupying the cross-section of the fiber, the smaller the lattice spacing (d 002 value) in the graphite layer as determined by X-ray diffractometry, or the larger the crystallite size (Lc) derived from the thicknesswise direction or the crystallite size (La) derived from the growth direction of the hexagonal net plane as determined by X-ray diffractometry, or the more likely the pitch carbon fiber exhibits thermal conduction, that is, the pitch carbon fiber has high thermal conductivity. Further, the larger the ratio of the melt mark occupying the cross-section of the fiber, the more remarkably the occurrence of cracking along the direction of the fiber axis of the carbon fiber can be decreased. The ratio of the melt mark occupying the cross-section of the fiber is preferably 70% or more, further preferably 80% or more. When the melt mark occupies 100% of the cross-section of the fiber, fusion of the adjacent carbon fibers is disadvantageously recognized. For this reason, it is necessary that the ratio of the melt mark occupying the cross-section of the fiber be less than 100%. A method for preferably obtaining the pitch carbon fiber of the invention having a melt mark in the fiber corresponding to 60 to less than 100% of the cross-section of the fiber is described later.

The pitch carbon fiber of the invention has a lattice spacing (d 002 value) of 0.3362 nm or less in the graphite layer and a crystallite size (Lc) of 60 nm or more derived from the thicknesswise direction, as determined by X-ray diffractometry. The d 002 value indicates a lattice spacing in the graphite layer constituting graphite, and the theoretical d 002 value of graphite is 0.3354 nm which is the substantial lower limit. It is considered that a carbon fiber having a d 002 value close to 0.3354 nm which is the theoretical value of graphite is highly graphitizable, but it is extremely difficult to artificially produce such a highly graphitizable carbon fiber.

A pitch carbon fiber having a lattice spacing (d 002 value) in the graphite layer as determined by X-ray diffractometry, which is close to 0.3354 nm, is highly graphitizable and more likely to exhibit thermal conduction and has high thermal conductivity. The d 002 value as determined by X-ray diffractometry is preferably 0.3360 nm or less, further preferably 0.3358 nm or less.

In the pitch carbon fiber, the crystallite size (Lc) derived from the thicknesswise direction of the graphite crystal is more preferably in the range of 60 nm, further preferably 70 nm to 200 nm as a substantial upper limit.

The pitch carbon fiber of the invention preferably has a crystallite size (La) of 130 nm or more, more preferably in the range of 150 to 300 nm, derived from the growth direction of the hexagonal net plane.

A preferred embodiment of the pitch carbon fiber of the invention is characterized in that when the surface of the fiber is observed by means of a scanning electron microscope at a magnification of 400 with respect to 100 pieces of the pitch carbon fiber, the number of pieces of the pitch carbon fiber having an occurrence of cracking in the surface of the fiber is 5 or less.

In the carbon fiber produced by a melt blowing method, pitch molecules are arranged in the direction perpendicular to the flow direction of the pitch passing through the spinning pore, but air at a high temperature is sprayed to both sides of the pitch expanded due to a Barus effect near the spinning pore, and therefore the resultant fiber has a cross-section of a symmetrical structure with respect to the line and hence is unlikely to exhibit a radial structure. A Barus effect means a phenomenon in which the pitch being discharged from the spinning pore is increased in the spinning diameter of the pitch, as compared to the spinning pore diameter.

However, like the fiber having a radial structure, the carbon fiber produced by a melt blowing method has a problem in that a stress strain is caused due to the shrinkage between molecular planes during the calcination, so that cracking occurs in the carbon fiber along the axis of line symmetry. The pitch carbon fiber of the invention, however, has almost no occurrence of cracking in the surface of the fiber. The reason for this is not clarified, but it is presumed that the melt mark occupying 60% or more of the cross-section of the pitch carbon fiber causes the symmetrical structure with respect to the line appearing in the cross-section of the fiber to disappear or decrease.

It is preferred that the pitch carbon fiber of the invention has a cross-section which is substantially elliptic. With respect to the shape of ellipse of the cross-section, there is no particular limitation, but it is preferred that in the cross-sectional image of the fiber taken by a scanning electron microscope at a magnification of 3,000 to 7,000, the ratio (DL/DS) of a long axis diameter (DL) to a short axis diameter (DS) is 1.2 to 5.0. By virtue of the elliptic cross-section, a carbon fiber having a decreased occurrence of cracking can be obtained. When the (DL/DS) value is more than 5.0, the pitch carbon fiber is unlikely to exhibit high graphitizability, making it difficult to achieve high thermal conductivity. On the other hand, when the (DL/DS) value is less than 1.2, in the case of producing a composite of the pitch carbon fiber with a resin, a satisfactory packing of the pitch carbon fiber may be difficult to obtain. The (DL/DS) value is more preferably 1.3 to 3.0.

The pitch carbon fiber of the invention preferably has an average fiber diameter of 2 to 20 μm, more preferably 11 to 18 μm. For achieving the average fiber diameter of the pitch carbon fiber in the invention, it is preferred to use a carbon fiber precursor having an average fiber diameter of 6 to 22 μm, further preferably 15 to 20 μm. By using a carbon fiber precursor having a diameter large to such an extent to produce a pitch carbon fiber having a diameter large to a certain extent, the carbon fiber of the invention having a melt mark in the fiber corresponding to 60 to less than 100% of the cross-section of the fiber can be preferably obtained.

### [Production Method]

Another object of the invention is to provide a method for producing a pitch carbon fiber which has a melt mark recognized in the fiber corresponding to 60 to less than 100% of the cross-section of the fiber, and which has a d 002 value of 0.3362 nm or less and a crystallite size (Lc) of 60 nm or more derived from the thicknesswise direction, as determined by X-ray diffractometry.

The pitch carbon fiber of the invention is preferably produced through (1) a step for preparing a pitch carbon fiber precursor from mesophase pitch by a melt blowing method, (2) a step for infusibilizing the pitch carbon fiber precursor in an oxidizing gas atmosphere to prepare a pitch infusibilized fiber, and (3) a step for calcining the infusibilized fiber to produce a pitch carbon fiber.

Hereinbelow, the steps in the method for producing the pitch carbon fiber of the invention are individually described.

### [Mesophase Pitch as Raw Material]

As a raw material for the pitch carbon fiber, mesophase pitch is preferred, and the mesophase pitch has a mesophase ratio of at least 90% or more, more preferably 95% or more, further preferably 99% or more. The mesophase ratio of mesophase pitch can be confirmed by observing the pitch in a molten state by a polarizing microscope. Examples of raw materials for mesophase pitch include fused polycyclic hydrocarbon compounds, such as naphthalene and phenanthrene, and fused heterocyclic compounds, such as petroleum pitch and coal pitch. Of these, preferred are fused polycyclic hydrocarbon compounds, such as naphthalene and phenanthrene.

Further, the raw material pitch preferably has a softening point of 230 to 340° C. It is necessary that the infusibilization treatment for a pitch carbon fiber precursor be performed at a temperature lower than the softening point of the raw material pitch. Therefore, when the softening point of the raw material pitch is lower than 230° C., the infusibilization treatment must be performed at a temperature at least lower than such a low softening point, so that the infusibilization requires a prolonged period of time. On the other hand, when the softening point is higher than 340° C., the pitch is likely to cause thermal decomposition, leading to a problem in that, for example, gas is generated to cause bubbles in the thread. The softening point is more preferably in the range of 250 to 320° C., further preferably 260 to 310° C. The softening point of the raw material pitch can be determined by a Mettler method. Two types or more of the raw material pitch may be used in combination. It is preferred that the raw material pitch used in the combination has a mesophase ratio of at least 90% or more and a softening point of 230 to 340° C.

[Step (1) for Preparing a Pitch Carbon Fiber Precursor from Mesophase Pitch by a Melt Blowing Method]

The pitch carbon fiber of the invention has a cross-section which is truly circular or preferably substantially elliptic, but, in any case, in step (1) for preparing a pitch carbon fiber precursor, a nozzle comprising a spinning pore of a circle, especially an inexpensive nozzle comprising a spinning pore of a true circle is preferably used. The carbon fiber having a melt mark in the fiber corresponding to 60 to less than 100% of the cross-section of the fiber can be preferably produced using a nozzle having a spinning pore of substantially a true circle when the melt viscosity of the pitch in the spinning pore is more than 1.0 to less than 10 Pa·s (more than 10 to less than 100 poises), the shear rate of the mesophase pitch passing through the spinning pore is more than 6,000 to less than 15,000 s⁻¹, and a gas at 4,000 to 12,000 m/minute, which is heated to a temperature that is the temperature ±20° C. of the pitch passing through the spinning pore, is sprayed to the mesophase pitch immediately below the spinning pore. For obtaining the carbon fiber having a melt mark in the fiber corresponding to 60 to less than 100% of the cross-section of the fiber, a preferred range of the melt viscosity of the pitch in the spinning pore is more than 1.0 to less than 6 Pa·s (more than 10 to less than 60 poises). When the melt viscosity of the pitch in the spinning pore is less than 0.5 Pa·s, the pitch discharged from the spinning pore becomes in a spherical shape due to the surface tension, making it difficult to prepare a pitch carbon fiber precursor. Further, when the melt viscosity of the pitch in the spinning pore is 0.5 Pa·s or more but less than 1.0 Pa·s, a pitch carbon fiber precursor having an appropriately large diameter cannot be obtained, making it difficult to produce a pitch carbon fiber having a melt mark in the fiber corresponding to 60 to less than 100% of the cross-section of the fiber.

When the fiber diameter of the carbon fiber precursor to be obtained is 6 to less than 11 μm, it is preferred that the pitch in the spinning pore has a melt viscosity of less than 7 Pa·s. With respect to the pitch having a melt viscosity of 7 Pa·s or more, even when air at a high temperature is sprayed to both sides of the pitch expanded due to a Barus effect near the spinning pore, not only cannot the shape of the cross-section of the pitch be changed due to the high viscosity of the pitch, but also the ultimately obtained pitch carbon fiber may be poor in graphitizability. The mesophase pitch as a raw material for the pitch carbon fiber forms a mesophase due to self-organization. Therefore, it is presumed that when the carbon fiber precursor has a fiber diameter of 6 to less than 11 μm, the pitch preferably has a viscosity of less than 7 Pa·s such that the appearance of the pitch is changed by the air sprayed to the pitch near the spinning pore to improve the orientation in the capillary due to self-organization, so that a pitch carbon fiber having a melt mark in the fiber corresponding to 60 to less than 100% of the cross-section of the fiber and having high thermal conductivity is produced.

When the fiber diameter of the carbon fiber precursor to be obtained is 11 to less than 22 μm, the pitch in the spinning pore may have a melt viscosity of more than 1.0 to less than 10 Pa·s. In the case where the fiber diameter of the carbon fiber precursor is 11 to less than 22 μm, even when the melt viscosity of the pitch in the spinning pore is 7 to less than Pa·s, a desired pitch carbon fiber having a melt mark recognized in the fiber corresponding to 60 to less than 100% of the cross-section of the fiber can be advantageously obtained. The reason for this is not clarified, but it is presumed that in the infusibilization in the next step, such a large fiber diameter of the carbon fiber precursor suppresses diffusion of oxygen in the direction of the fiber cross-section, so that carbonization of the pitch proceeds in the liquid phase to form a melt mark, thus promoting the growth of crystals due to the rearrangement of pitch molecules.

For producing the pitch carbon fiber of the invention, it is preferred that, in step (1) for preparing a pitch carbon fiber precursor, the pitch carbon fiber precursor has an orientation degree of 83.5% or more as evaluated using X-rays. When the pitch carbon fiber precursor has an orientation degree of 83.5% or more as evaluated using X-rays, the pitch carbon fiber having a d 002 value of 0.3362 nm or less and a crystallite size (Lc) of 60 nm or more derived from the thicknesswise direction as determined by X-ray diffractometry can be preferably produced. The reason for this is presumed as follows. When the orientation degree of the pitch carbon fiber precursor is low, there is a tendency that the hexagonal net plane layers cannot be joined to one another at their end faces during the carbonization and hence cannot grow into large crystals. However, by increasing the orientation degree, the hexagonal net plane layers can be joined to one another at their end faces during the carbonization.

The pitch carbon fiber precursor having an orientation degree of 83.5% or more as evaluated using X-rays can be obtained when the mesophase pitch passing through the spinning pore has a shear rate of more than 6,000 to less than 15,000 s⁻¹ and a gas at 4,000 to 12,000 m/minute, which is heated to a temperature that is the temperature ±20° C. of the pitch passing through the spinning pore, is sprayed to the mesophase pitch immediately below the spinning pore. When the mesophase pitch passing through the spinning pore has a shear rate of less than 6,000 s⁻¹, shearing of the mesophase pitch in the spinning pore becomes unsatisfactory, so that the orientation degree of the pitch carbon fiber precursor may become less than 83.5%. On the other hand, when the mesophase pitch passing through the spinning pore has a shear rate of 15,000 s⁻¹ or more, the thread diameter of the pitch carbon fiber precursor becomes so large that the infusibilization of the pitch carbon fiber precursor in the next step requires an extremely prolonged period of time, leading to a lowering of the productivity. The mesophase pitch passing through the spinning pore more preferably has a shear rate in the range of more than 7,000 to less than 14,000 s⁻¹. It is preferred that the air sprayed to the mesophase pitch immediately below the spinning pore is heated for preventing the pitch near the spinning pore from being solidified. The temperature of the air is in the range of the temperature ±20° C. of the pitch passing through the spinning pore. The temperature of the air varies depending on the type of the pitch used, but, specifically, the temperature of the air is preferably in the range of 340 to 370° C. When the temperature of the air is lower than the temperature of the pitch minus 20° C., the pitch immediately below the spinning pore is rapidly cooled, and hence the resultant fiber is likely to have a cross-section of a symmetrical structure with respect to the line, and the application of a stress to the carbon fiber obtained after calcination easily causes a stress strain (cracking) along the axis of line symmetry of the cross-section of the fiber, so that microdefects are caused in the fiber, leading to a marked lowering of the physical properties of the fiber. On the other hand, when the temperature of the air is higher than the temperature of the pitch plus 20° C., the raw material thread is likely to be increased in randomness to make it impossible to achieve an orientation degree of 83.5%, so that the hexagonal net plane layers cannot be joined to one another at their end faces during the carbonization.

The air flow rate immediately below the spinning pore is preferably in the range of 4,000 to 12,000 m/minute. The air flow rate immediately below the spinning pore is estimated by determining by calculation a flow rate of the heated air expanded in volume from a flow rate of air before heated, which is estimated by a flow meter, and dividing it by the sectional area of the air discharge portion.

The higher the air flow rate immediately below the spinning pore, the lower the orientation degree of the pitch carbon fiber precursor. Therefore, when the air flow rate immediately below the spinning pore is more than 12,000 m/minute, the pitch carbon fiber precursor having an orientation degree of 83.5% or more may be difficult to obtain, making it difficult to produce a pitch carbon fiber having a melt mark recognized in the fiber corresponding to 60 to less than 100% of the cross-section of the fiber. On the other hand, when the air flow rate is less than 4,000 m/minute, the orientation degree of the pitch carbon fiber precursor is increased, but the thread diameter of the pitch carbon fiber precursor is likely to become so large that the infusibilization of the pitch carbon fiber precursor in the next step requires an extremely prolonged period of time, leading to a lowering of the productivity. The air flow rate immediately below the spinning pore is more preferably in the range of 5,000 to 8,000 m/minute.

The pitch carbon fiber precursor is collected by a belt, such as a wire mesh, to form a pitch carbon fiber precursor web. In this instance, the Fiber Areal Weight of the web can be arbitrarily controlled by changing the belt conveying speed, and, if necessary, the pitch carbon fiber precursor web may be stacked on one another by a crosslap method or the like. Taking the productivity and process stability into consideration, the Fiber Areal Weight of the pitch carbon fiber precursor web is preferably 150 to 1,000 g/m². The pitch carbon fiber precursor preferably has an average fiber length in the range of 4 to 25 cm. When the pitch carbon fiber precursor has an average fiber length of less than 4 cm, the pitch carbon fiber precursor web collected on a belt, such as a wire mesh, is markedly reduced in strength, making it difficult to stack the web by a crosslap method or the like, leading to a lowering of the productivity. On the other hand, when the pitch carbon fiber precursor has an average fiber length of more than 25 cm, the pitch carbon fiber precursor web becomes so bulky that in the infusibilization in the next step, the reaction heat caused in a reaction between the pitch carbon fiber precursor web and oxidizing gas is difficult to remove. Such a disadvantage possibly causes a problem in that the pitch carbon fiber precursor web is burnt up. The pitch carbon fiber precursor more preferably has an average fiber length in the range of 5 to 10 cm.

### [Step (2): Infusibilization of Pitch Carbon Fiber Precursor]

The pitch carbon fiber of the invention can be preferably produced by infusibilizing the above-mentioned pitch carbon fiber precursor or pitch carbon fiber precursor web in an oxidizing gas atmosphere to prepare a pitch infusibilized fiber, wherein the amount of oxygen deposited onto the pitch infusibilized fiber is in the range of 5.5 to 7.5 wt %. When the amount of oxygen deposited onto the pitch infusibilized fiber is less than 5.5 wt % and the pitch infusibilized fiber is subjected to calcination step to obtain a carbon fiber, the resultant carbon fiber has a melt mark recognized in the fiber corresponding to 60% or more of the cross-section of the fiber, but it is likely that the melt mark occupies 100% of the cross-section of the fiber, and fusion of the pitch carbon fibers is disadvantageously found. On the other hand, when the amount of oxygen deposited onto the pitch infusibilized fiber is more than 7.5 wt % and the pitch infusibilized fiber is subjected to calcination step to obtain a carbon fiber, the resultant carbon fiber has a melt mark recognized in the fiber corresponding to less than 60% of cross-section of the fiber, and a lamellar arrangement comprising an aggregate of a great number of small crystals (domains) is observed in the fiber. Thus, heat as a resistance is caused at the joints between the crystals, so that the carbon fiber is unlikely to exhibit large thermal conduction. The amount of oxygen deposited onto the pitch infusibilized fiber is preferably in the range of 6.2 to 7.3 wt %, more preferably in the range of 6.4 to 7.0 wt %. The reason why the amount of oxygen deposited onto the pitch infusibilized fiber has an effect on the ratio of the melt mark occupying the cross-section of the calcined pitch carbon fiber is not clarified, but it is presumed that when the amount of oxygen deposited onto the infusibilized fiber is small, diffusion of oxygen in the direction of the fiber cross-section is unsatisfactory, so that carbonization of the pitch proceeds in the liquid phase, thus promoting the growth of crystals due to the rearrangement of pitch molecules.

The infusibilization of the pitch carbon fiber precursor is conducted in an oxidizing gas atmosphere, and the oxidizing gas in the invention indicates air or mixed gas of air and a gas capable of drawing an electron from the pitch carbon fiber precursor. Examples of the gas capable of drawing an electron from the pitch carbon fiber precursor include ozone, iodine, bromine, and oxygen. However, taking into consideration the safety, convenience, and cost performance, the infusibilization of the pitch carbon fiber precursor is especially desirably conducted in air.

The infusibilization can be conducted either in a batchwise manner or in a continuous manner, but, taking the productivity into consideration, the infusibilization is desirably conducted in a continuous manner. The infusibilization treatment is preferably performed at a temperature of 150 to 350° C. The temperature is more preferably in the range of 160 to 340° C. In the infusibilization conducted in a batchwise manner, a temperature increase rate of 1 to 10° C./minute is preferably used. Taking the productivity and process stability into consideration, the temperature increase rate is more preferably in the range of 3 to 9° C./minute. In the infusibilization conducted in a continuous manner, the pitch carbon fiber precursor is successively passed through a plurality of reaction chambers each adjusted to an arbitrary temperature to achieve the above-mentioned temperature increase rate. For successively passing the pitch carbon fiber precursor through a plurality of reaction chambers, a conveyer or the like may be used. The amount of oxygen deposited onto the pitch carbon fiber precursor heavily depends on the temperature in the furnace and the residence time in the furnace. In the infusibilization conducted in a continuous manner, it is preferred that the residence time in each reaction chamber is controlled by appropriately selecting the speed of the conveyer and the temperature in each reaction chamber so that the amount of oxygen deposited onto the pitch infusibilized fiber becomes 5.5 to 7.5 wt %. The speed of the conveyer varies depending on the number and size of the reaction chambers, but is preferably 0.1 to 1.5 m/minute.

### [Step (3): Calcination]

Subsequently, in step (3), the infusibilized fiber or infusibilized fiber web is calcined at 2,000 to 3,400° C. to obtain a pitch carbon fiber or a pitch carbon fiber web. It is preferred that the calcination of the pitch infusibilized fiber at lower than 2,000° C. is performed in a vacuum or in a non-oxidizing atmosphere using an inert gas, such as nitrogen, argon, or krypton. The calcination of the pitch infusibilized fiber at lower than 2,000° C. can be conducted either in a batchwise manner or in a continuous manner, but, taking the productivity into consideration, the calcination is desirably conducted in a continuous manner. In the calcination at higher than 2,000° C., the atmosphere gas is ionized, and therefore an inert gas, such as argon or krypton, is preferably used for the atmosphere.

In the invention, for obtaining a desired fiber length, the pitch carbon fiber obtained by calcination of the pitch infusibilized fiber or infusibilized fiber web at 600 to 2,000° C. may be subjected to treatment, such as cutting, or crushing or grinding. Further, if desired, the resultant pitch carbon fiber may be subjected to classification treatment. The type of treatment is selected according to a desired fiber length, but, in the cutting, a cutter of a guillotine type, a mono-axial, biaxial, or multi-axial rotary type, or the like is preferably used, and, in the crushing or grinding, a crusher or grinder of a hammer type, a pin type, a ball type, a bead type, or a rod type utilizing a shock action, a high-speed rotary type utilizing collision of the particles, a roll type, a cone type, or a screw type utilizing a compression or tearing action, or the like is preferably used. For obtaining a desired fiber length, a plurality of apparatuses for cutting and crushing or grinding may be employed. The atmosphere for treatment may be either wet or dry. In the classification treatment, a classification apparatus of a vibrating sieve type, a centrifugal separation type, an inertia force type, a filtration type, or the like is preferably used. A desired fiber length can be obtained not only by appropriately selecting the type of the apparatus but also by controlling the number of revolutions of the rotor, rotary cutter blade, or the like, the feed rate, the clearance between blades, the residence time in the system, or the like. Further, when using a classification treatment, a desired fiber length can also be obtained by controlling the sieve mesh pore diameter or the like. By these treatments, a pitch carbon short fiber may be obtained.

In the invention, the above-obtained pitch carbon fiber, pitch carbon fiber web, or pitch carbon short fiber is further calcined at a temperature of 2,000° C. or higher to obtain the pitch carbon fiber of the invention. For producing the pitch carbon fiber of the invention, the calcination is more preferably conducted at a temperature in the range of 2,300 to 3,400° C., further preferably 2,700 to 3,200° C. The calcination at 2,000° C. or higher is conducted in an Acheson furnace, an electric furnace, or the like, and conducted in a vacuum or in a non-oxidizing atmosphere using an inert gas, such as nitrogen, argon, or krypton.

### EXAMPLES

Hereinbelow, the present invention will be described in more detail with reference to the following Examples, which should not be construed as limiting the scope of the present invention. In the following Examples, the values were individually determined by the methods described below.

### (1) Average Fiber Diameter and Fiber Diameter Variance of the Pitch Carbon Fiber

With respect to 60 pieces of the pitch carbon fiber, a fiber diameter was measured using a scale under an optical microscope, and an average was determined. A CV value was determined as a ratio of the deviation (S) of the fiber diameter to the obtained average fiber diameter (Ave) from the following formula.

CV=S/Ave×100

wherein S=√((ΣX−Ave)²/n) wherein X is a measured value and n is the number of measurements.
(2) Amount of Oxygen Deposited onto the Pitch Infusibilized Fiber

The amount of oxygen deposited onto the pitch infusibilized fiber was evaluated by means of CHNS-O Analyzer (FLASH EA 1112 Series, manufactured by Thermo ELECTRON CORPORATION).

### (3) Evaluation of d 002, Lc, and La by X-Ray Diffractometry

A lattice spacing (d 002) in the graphite layer constituting graphite and a crystallite size (Lc) derived from the thicknesswise direction of the hexagonal net plane were determined using diffraction lines from the (002) plane, and a crystallite size (La) derived from the growth direction of the hexagonal net plane was determined using diffraction lines from the (110) plane. The determination was conducted in accordance with a Gakushin method.

### (4) Observation of Shape of the Cross-Section of Fiber

The shape of the cross-section of fiber was determined by calculating an average of the ratio (DL/DS) of a long axis diameter (DL) to a short axis diameter (DS) with respect to 10 fields of view of the cross-sectional image of the fiber taken by a scanning electron microscope at a magnification of 4,000 to 6,000. Further, a melt mark ratio was determined by calculating an average of the melt mark ratio with respect to 10 fields of view of the cross-sectional image of the fiber. The melt mark ratio was determined by measuring areas of the cross-section of fiber and the melt mark in a specified region using a soft for image processing (Image J) and applying the areas to the following formula.

Melt mark ratio=100×(Area of melt mark)/(Area of cross-section of fiber)

The number of cracking in the surface of the fiber was determined by observing the surface of the fiber by means of a scanning electron microscope at a magnification of 400 with respect to 100 pieces of the pitch carbon fiber and measuring the number of piece (s) of the pitch carbon fiber having cracking in the surface of the fiber.

### (5) Measurement of Melt Viscosity

A viscosity of the pitch passing through the capillary was determined using a capillary rheometer CAPILOGRAPH 1D (manufactured by Toyo Seiki Seisaku-Sho, Ltd.). A shear rate of the mesophase pitch passing through the capillary was determined from the following formula (a).

γ=8V/D (a)

wherein γ means a shear rate (s⁻¹) of the mesophase pitch in the capillary, D means a pore diameter (m) of the capillary, and V means a flow rate (m/s) of the mesophase pitch in the capillary.

A flow rate of the mesophase pitch in the capillary was determined by calculating a speed of the pitch passing through the capillary from the feed amount per unit time fed from a gear pump.

Further, a pitch temperature was determined by monitoring a resin pressure sensor having a thermocouple, NP463-1/2-10 MPA-15/45-K (manufactured by DYNISCO JAPAN, LTD.), which was provided on the upper portion of the capillary.

### (6) Softening Point

A softening point was determined using METTLER FP90 (manufactured by Mettler-Toledo International Inc.) by increasing the temperature from 260° C. at 1° C./minute in a nitrogen atmosphere.

### (7) Orientation Degree of Pitch Carbon Fiber Precursor

A pitch carbon fiber precursor was collected in a state such that the precursor was pulled and arranged in the direction of the fiber axis immediately below the nozzle, and then a sample of the precursor was placed on a fiber sample support and subjected to measurement by wide-angle X-ray diffractometry (β scanning). Model 4036A2, manufactured by Rigaku Corporation, was used as an X-ray diffactometer, and model 2155D, manufactured by Rigaku Corporation, was used as a goniometer which is an apparatus for measuring an angle of a crystal plane, and measurement was made in the measurement range (β) of 90 to 270° at a step width of 0.5°. An orientation degree was calculated from a half band width of the intensity distribution obtained by scanning (β scanning) the diffraction peaks in the circumferential direction, using the following formula (b).

Orientation degree=(180−H)/180 (b)

wherein H represents a half band width (deg.).

### Example 1

Mesophase pitch comprising an aromatic hydrocarbon and having a mesophase ratio of 100% and a softening temperature of 277° C. was fed at 341° C. and at a capillary flow rate of 0.185 m/s (shear rate γ: 7,400 s⁻¹) using a nozzle comprising a spinning pore of a true circle having a diameter of 0.2 mmφ and a length of 2 mm, while spraying air at 348° C. and at 6,172 m per minute from a slit adjacent to the spinning pore, to pull the molten mesophase pitch, thereby preparing a web comprising a carbon fiber precursor having an average diameter of 17.3 μm. A melt viscosity evaluated by a capillary rheometer at 341° C. and at a shear rate of 7,400 s⁻¹ was 4.2 (Pa·s). The pitch carbon fiber precursor collected immediately below the nozzle had an orientation degree of 84.5%. Then, the web comprising the carbon fiber precursor was increased in temperature from 200 to 320° C. in an air atmosphere over 30 minutes to obtain a web comprising an infusibilized carbon fiber. The amount of oxygen deposited onto the infusibilized carbon fiber was 6.3 wt %. Subsequently, the above-obtained web comprising the pitch infusibilized fiber was calcined in an argon gas atmosphere by increasing the temperature from room temperature to 3,000° C. over 5 hours to prepare a web comprising a pitch carbon fiber.

The obtained pitch carbon fiber had an average fiber diameter of 13.1 μm and a fiber diameter CV value of 10.2%. The shape of the cross-section of the pitch carbon fiber was substantially an ellipse, and, with respect to 10 fields of view of the cross-sectional image of the fiber taken by a scanning electron microscope at a magnification of 6,000, an average of the ratio (DL/DS) of a long axis diameter (DL) to a short axis diameter (DS) was 1.6, and a melt mark ratio was 87%. Further, d 002 was 0.3358 (nm), Lc was 89 (nm), and La was 153 (nm), as determined by X-ray diffractometry, and the observation of the surface of the pitch carbon fiber at a magnification of 400 showed that among 100 pieces of the pitch carbon fiber, 3 pieces had cracking. A scanning electron photomicrograph of the cross-section is shown in FIG. 1.

### Example 2

A pitch carbon fiber was produced in substantially the same manner as in Example 1 except that the web comprising the pitch infusibilized fiber in Example 1 was calcined in an argon gas atmosphere at from room temperature to 800° C. over 0.5 hour, and then ground by means of a turbo-mill, and then the resultant pitch carbon short fiber was calcined in an argon gas atmosphere at from room temperature to 3,000° C. over 5 hours.

The obtained pitch carbon fiber had an average fiber diameter of 12.8 μm and a fiber diameter CV value of 11.2%. The shape of the cross-section of the pitch carbon fiber was substantially an ellipse, and, with respect to 10 fields of view of the cross-sectional image of the fiber taken by a scanning electron microscope at a magnification of 4,000, an average of the ratio (DL/DS) of a long axis diameter (DL) to a short axis diameter (DS) was 1.6, and a melt mark ratio was 87%. Further, d 002 was 0.3360 (nm), Lc was 72 (nm), and La was 138 (nm), as determined by X-ray diffractometry, and the observation of the surface of the pitch carbon fiber at a magnification of 400 showed that among 100 pieces of the pitch carbon fiber, 4 pieces had cracking.

### Example 3

Mesophase pitch comprising an aromatic hydrocarbon and having a mesophase ratio of 100% and a softening temperature of 276° C. was fed at 346° C. and at a capillary flow rate of 0.223 m/s (shear rate γ: 8,920 s⁻¹) using a nozzle comprising a spinning pore of a true circle having a diameter of 0.2 mmφ and a length of 2 mm, while spraying air at 353° C. and at 6,940 m per minute from a slit adjacent to the spinning pore, to pull the molten mesophase pitch, thereby preparing a web comprising a carbon fiber precursor having an average diameter of 16.3 μm. A melt viscosity evaluated by a capillary rheometer at 346° C. and at a shear rate of 8,920 s⁻¹ was 2.9 (Pa·s). The pitch carbon fiber precursor collected immediately below the nozzle had an orientation degree of 85.1%. Then, the web comprising the carbon fiber precursor was increased in temperature from 200 to 310° C. in an air atmosphere over 30 minutes to obtain a web comprising an infusibilized carbon fiber. The amount of oxygen deposited onto the infusibilized carbon fiber was 6.4 wt %. Subsequently, the above-obtained nonwoven fabric comprising the pitch infusibilized fiber was calcined in an argon gas atmosphere at from room temperature to 3,000° C. over 5 hours to prepare a web comprising a pitch carbon fiber.

The obtained pitch carbon fiber had an average fiber diameter of 12.4 μm and a fiber diameter CV value of 10.8%. The shape of the cross-section of the pitch carbon fiber was substantially an ellipse, and, with respect to 10 fields of view of the cross-sectional image of the fiber taken by a scanning electron microscope at a magnification of 4,000, an average of the ratio (DL/DS) of a long axis diameter (DL) to a short axis diameter (DS) was 1.7, and a melt mark ratio was 78%. Further, d 002 was 0.3359 (nm), Lc was 78 (nm), and La was 143 (nm), as determined by X-ray diffractometry, and the observation of the surface of the pitch carbon fiber at a magnification of 400 showed that among 100 pieces of the pitch carbon fiber, 3 pieces had cracking.

### Example 4

Mesophase pitch comprising an aromatic hydrocarbon and having a mesophase ratio of 100% and a softening temperature of 277° C. was fed at 341° C. and at a capillary flow rate of 0.185 m/s (shear rate γ: 7,400 s⁻¹) using a nozzle comprising a spinning pore of a true circle having a diameter of 0.2 mmφ and a length of 2 mm, while spraying air at 348° C. and at 6,172 m per minute from a slit adjacent to the spinning pore, to pull the molten mesophase pitch, thereby preparing a web comprising a carbon fiber precursor having an average diameter of 17.3 μm. A melt viscosity evaluated by a capillary rheometer at 341° C. and at a shear rate of 7,400 s⁻¹ was 4.2 (Pa·s). The pitch carbon fiber precursor collected immediately below the nozzle had an orientation degree of 84.5%. Then, the web comprising the carbon fiber precursor was increased in temperature from 200 to 335° C. in an air atmosphere over 30 minutes to obtain a web comprising an infusibilized carbon fiber. The amount of oxygen deposited onto the infusibilized carbon fiber was 7.4 wt %. Subsequently, the above-obtained web comprising the pitch infusibilized fiber was calcined in an argon gas atmosphere by increasing the temperature from room temperature to 3,000° C. over 5 hours to prepare a web comprising a pitch carbon fiber.

The obtained pitch carbon fiber had an average fiber diameter of 13.1 μm and a fiber diameter CV value of 10.2%. The shape of the cross-section of the pitch carbon fiber was substantially an ellipse, and, with respect to 10 fields of view of the cross-sectional image of the fiber taken by a scanning electron microscope at a magnification of 6,000, an average of the ratio (DL/DS) of a long axis diameter (DL) to a short axis diameter (DS) was 1.5, and a melt mark ratio was 69%. Further, d 002 was 0.3361 (nm), Lc was 63 (nm), and La was 131 (nm), as determined by X-ray diffractometry, and the observation of the surface of the pitch carbon fiber at a magnification of 400 showed that among 100 pieces of the pitch carbon fiber, 3 pieces had cracking.

### Example 5

Mesophase pitch comprising an aromatic hydrocarbon and having a mesophase ratio of 100% and a softening temperature of 276° C. was fed at 338° C. and at a capillary flow rate of 0.223 m/s (shear rate γ: 8,920 s⁻¹) using a nozzle comprising a spinning pore of a true circle having a diameter of 0.2 mmφ and a length of 2 mm, while spraying air at 343° C. and at 6,245 m per minute from a slit adjacent to the spinning pore, to pull the molten mesophase pitch, thereby preparing a web comprising a carbon fiber precursor having an average diameter of 18.6 μm. A melt viscosity evaluated by a capillary rheometer at 338° C. and at a shear rate of 8,920 s⁻¹ was 8.6 (Pa·s). The pitch carbon fiber precursor collected immediately below the nozzle had an orientation degree of 84.3%. Then, the web comprising the carbon fiber precursor was increased in temperature from 200 to 310° C. in an air atmosphere over 30 minutes to obtain a web comprising an infusibilized carbon fiber. The amount of oxygen deposited onto the infusibilized carbon fiber was 5.7 wt %. Subsequently, the above-obtained nonwoven fabric comprising the pitch infusibilized fiber was calcined in an argon gas atmosphere at from room temperature to 3,000° C. over 5 hours to prepare a web comprising a pitch carbon fiber.

The obtained pitch carbon fiber had an average fiber diameter of 14.3 μm and a fiber diameter CV value of 11.7%. The shape of the cross-section of the pitch carbon fiber was substantially a true circle, and, with respect to 10 fields of view of the cross-sectional image of the fiber taken by a scanning electron microscope at a magnification of 4,000, an average of the ratio (DL/DS) of a long axis diameter (DL) to a short axis diameter (DS) was 1.0, and a melt mark ratio was 93%. Further, d 002 was 0.3357 (nm), Lc was 87 (nm), and La was 216 (nm), as determined by X-ray diffractometry, and the observation of the surface of the pitch carbon fiber at a magnification of 400 showed that among 100 pieces of the pitch carbon fiber, 5 pieces had cracking.

### Example 6

Mesophase pitch comprising an aromatic hydrocarbon and having a mesophase ratio of 100% and a softening temperature of 276° C. was fed at 338° C. and at a capillary flow rate of 0.223 m/s (shear rate γ: 8,920 s⁻¹) using a nozzle comprising a spinning pore of a true circle having a diameter of 0.2 mmφ and a length of 2 mm, while spraying air at 343° C. and at 6,940 m per minute from a slit adjacent to the spinning pore, to pull the molten mesophase pitch, thereby preparing a web comprising a carbon fiber precursor having an average diameter of 17.8 μm. A melt viscosity evaluated by a capillary rheometer at 338° C. and at a shear rate of 8,920 s⁻¹ was 8.6 (Pa·s). The pitch carbon fiber precursor collected immediately below the nozzle had an orientation degree of 84.3%. Then, the web comprising the carbon fiber precursor was increased in temperature from 200 to 310° C. in an air atmosphere over 30 minutes to obtain a web comprising an infusibilized carbon fiber. The amount of oxygen deposited onto the infusibilized carbon fiber was 6.6 wt %. Subsequently, the above-obtained nonwoven fabric comprising the pitch infusibilized fiber was calcined in an argon gas atmosphere at from room temperature to 3,000° C. over 5 hours to prepare a web comprising a pitch carbon fiber.

The obtained pitch carbon fiber had an average fiber diameter of 13.1 μm and a fiber diameter CV value of 11.2%. The shape of the cross-section of the pitch carbon fiber was substantially a true circle, and, with respect to 10 fields of view of the cross-sectional image of the fiber taken by a scanning electron microscope at a magnification of 4,000, an average of the ratio (DL/DS) of a long axis diameter (DL) to a short axis diameter (DS) was 1.0, and a melt mark ratio was 84%. Further, d 002 was 0.3360 (nm), Lc was 68 (nm), and La was 208 (nm), as determined by X-ray diffractometry, and the observation of the surface of the pitch carbon fiber at a magnification of 400 showed that among 100 pieces of the pitch carbon fiber, 5 pieces had cracking. A scanning electron photomicrograph of the cross-section is shown in FIG. 2.

### Comparative Example 1

Mesophase pitch comprising an aromatic hydrocarbon and having a mesophase ratio of 100% and a softening temperature of 277° C. was fed at 333° C. and at a capillary flow rate of 0.148 m/s (shear rate γ: 5,900 s⁻¹) using a nozzle comprising a spinning pore of a true circle having a diameter of 0.2 mmφ and a length of 2 mm, while spraying air at 340° C. and at 10,800 m per minute from a slit adjacent to the spinning pore, to pull the molten mesophase pitch, thereby preparing a web comprising a carbon fiber precursor having an average diameter of 11.3 μm. A melt viscosity evaluated by a capillary rheometer at 333° C. and at a shear rate of 5,900 s⁻¹ was 14.8 (Pa·s). The pitch carbon fiber precursor collected immediately below the nozzle had an orientation degree of 82.4%. Then, the web comprising the carbon fiber precursor was increased in temperature from 200 to 293° C. in an air atmosphere over 30 minutes to obtain a web comprising an infusibilized carbon fiber. The amount of oxygen deposited onto the infusibilized carbon fiber was 7.5 wt %. Subsequently, the above-obtained web comprising the pitch infusibilized fiber was calcined in an argon gas atmosphere at from room temperature to 3,000° C. over 5 hours to prepare a web comprising a pitch carbon fiber.

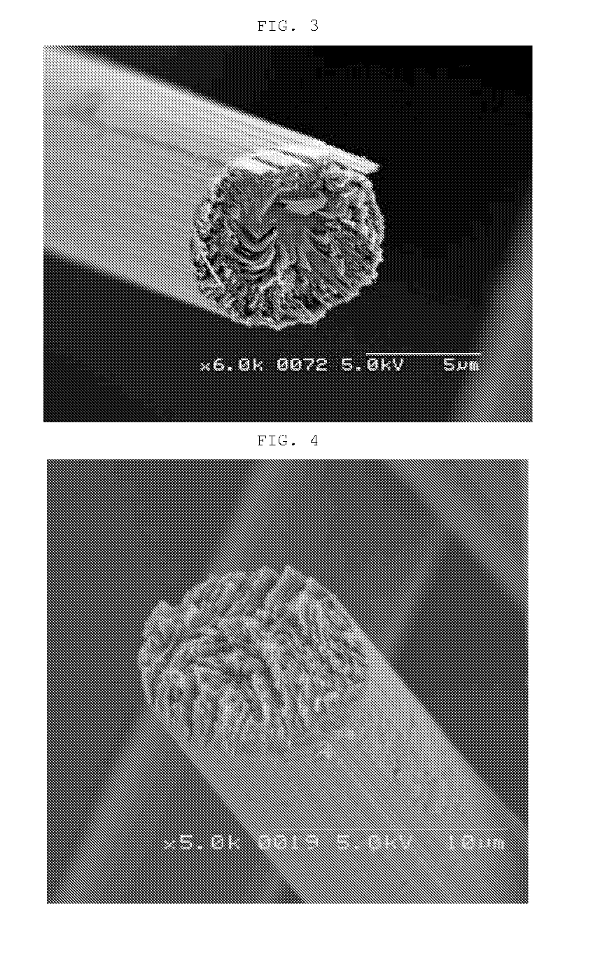

The obtained pitch carbon fiber had an average fiber diameter of 9.1 μm and a fiber diameter CV value of 12.2%. With respect to 10 fields of view of the cross-sectional image of the fiber taken by a scanning electron microscope at a magnification of 5,000, an average of the ratio (DL/DS) of a long axis diameter (DL) to a short axis diameter (DS) was 1.0, and a melt mark ratio was 20%. Further, d 002 was 0.3366 (nm), Lc was 38 (nm), and La was 72 (nm), as determined by X-ray diffractometry, and the observation of the surface of the pitch carbon fiber at a magnification of 400 showed that among 100 pieces of the pitch carbon fiber, 11 pieces had cracking. A scanning electron photomicrograph of the cross-section is shown in FIG. 3. An example of a photograph of the surface of the pitch carbon fiber at a magnification of 400 is shown in FIG. 6. With respect to the surface of the pitch carbon fiber at the middle of the photograph, the occurrence of cracking in the surface along the direction of the fiber axis is observed.

### Comparative Example 2

Mesophase pitch comprising an aromatic hydrocarbon and having a mesophase ratio of 100% and a softening temperature of 276° C. was fed at 338° C. and at a capillary flow rate of 0.223 m/s (shear rate γ: 8,920 s⁻¹) using a nozzle comprising a spinning pore of a true circle having a diameter of 0.2 mmφ and a length of 2 mm, while spraying air at 343° C. and at 10,800 m per minute from a slit adjacent to the spinning pore, to pull the molten mesophase pitch, thereby preparing a web comprising a carbon fiber precursor having an average diameter of 15.3 μm. A melt viscosity evaluated by a capillary rheometer at 338° C. and at a shear rate of 8,920 s⁻¹ was 9.2 (Pa·s). The pitch carbon fiber precursor collected immediately below the nozzle had an orientation degree of 83.2%. Then, the web comprising the carbon fiber precursor was increased in temperature from 200 to 320° C. in an air atmosphere over 30 minutes to obtain a web comprising an infusibilized carbon fiber. The amount of oxygen deposited onto the infusibilized carbon fiber was 7.6 wt %. Subsequently, the above-obtained web comprising the pitch infusibilized fiber was calcined in an argon gas atmosphere at from room temperature to 3,000° C. over 5 hours to prepare a web comprising a pitch carbon fiber.

The obtained pitch carbon fiber had an average fiber diameter of 10.3 μm and a fiber diameter CV value of 9.8%. With respect to 10 fields of view of the cross-sectional image of the fiber taken by a scanning electron microscope at a magnification of 4,000, an average of the ratio (DL/DS) of a long axis diameter (DL) to a short axis diameter (DS) was 1.0, and a melt mark ratio was 57%. Further, d 002 was 0.3363 (nm), Lc was 41 (nm), and La was 85 (nm), as determined by X-ray diffractometry, and the observation of the surface of the pitch carbon fiber at a magnification of 400 showed that among 100 pieces of the pitch carbon fiber, 13 pieces had cracking.

### Comparative Example 3

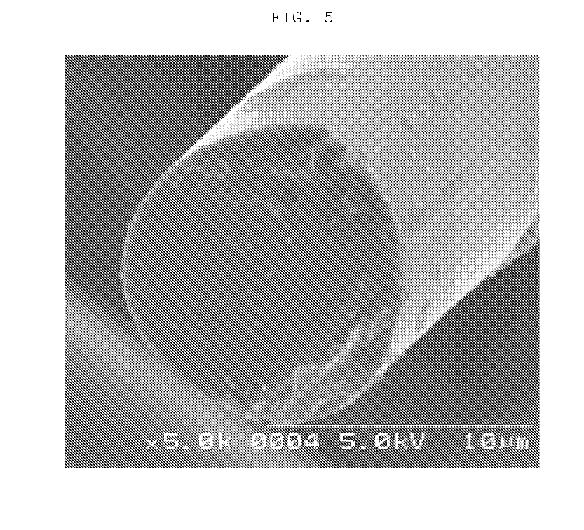

Graphitized carbon fiber (grade: DKD), manufactured by Cytec Industries Inc., had an average fiber diameter of 9.4 μm and a fiber diameter CV value of 8.1%. With respect to 10 fields of view of the cross-sectional image of the fiber taken by a scanning electron microscope at a magnification of 4,000, an average of the ratio (DL/DS) of a long axis diameter (DL) to a short axis diameter (DS) was 1.0, and a melt mark ratio was 5%. Further, d 002 was 0.3374 (nm), Lc was 36 (nm), and La was (nm), as determined by X-ray diffractometry. A scanning electron photomicrograph of the cross-section is shown in FIG. 4.

### Comparative Example 4

Graphitized carbon fiber (grade: XN-100), manufactured by Nippon Graphite Fiber Corporation, had an average fiber diameter of 8.7 μm and a fiber diameter CV value of 7.2%. With respect to 10 fields of view of the cross-sectional image of the fiber taken by a scanning electron microscope at a magnification of 4,000, an average of the ratio (DL/DS) of a long axis diameter (DL) to a short axis diameter (DS) was 1.0, and a melt mark ratio was 33%. Further, d 002 was 0.3366 (nm), Lc was 53 (nm), and La was 35 (nm), as determined by X-ray diffractometry.

### Comparative Example 5

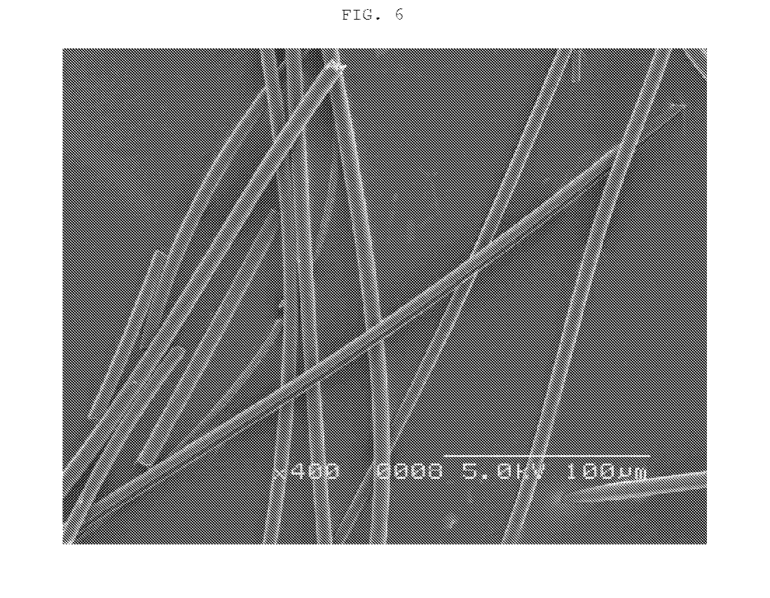

Graphitized carbon fiber (grade: KRECA FELT G), manufactured by KUREHA CORPORATION, had an average fiber diameter of 14.3 μm and a fiber diameter CV value of 12.2%. With respect to 10 fields of view of the cross-sectional image of the fiber taken by a scanning electron microscope at a magnification of 5,000, an average of the ratio (DL/DS) of a long axis diameter (DL) to a short axis diameter (DS) was 1.0, and a melt mark ratio was 0%. Further, any of d 002, Lc, and La as determined by X-ray diffractometry were not observed, which indicated that the carbon fiber was in a non-oriented, glassy state. A scanning electron photomicrograph of the cross-section is shown in FIG. 5.

### Comparative Example 6

Mesophase pitch comprising an aromatic hydrocarbon and having a mesophase ratio of 100%, a softening temperature of 276° C., and a melt viscosity of 3.2 Pa·s (32 poises) at 340° C. and at a shear rate of 10,000 s⁻¹ was fed at 320° C. and at a capillary flow rate of 0.078 m/s (shear rate: 3,116 s⁻¹) using a nozzle comprising a capillary having a diameter of 0.2 mmφ and a length of 2 mm, while spraying air at 322° C. and at 5,500 m per minute from a slit adjacent to the capillary, to pull the molten mesophase pitch by a melt blowing method, preparing a web comprising a carbon fiber precursor having an average diameter of 12 μm. A melt viscosity in the capillary evaluated by a capillary rheometer at 320° C. and at 0.078 m/s was 23.7 Pa·s (237 poises). The amount of oxygen deposited onto the infusibilized carbon fiber was 6.7 wt %. Then, the web comprising the infusibilized fiber was calcined in an argon gas atmosphere at from room temperature to 3,000° C. over 5 hours to prepare a web comprising a pitch carbon fiber. The obtained pitch carbon fiber had an average fiber diameter of 8.9 μm and a fiber diameter CV value of 11.5%. The shape of the cross-section of the pitch carbon fiber was substantially a true circle of a radial structure, and, with respect to 10 fields of view of the cross-sectional image of the fiber taken by a scanning electron microscope at a magnification of 6,000, an average of the ratio (DL/DS) of a long axis diameter (DL) to a short axis diameter (DS) was 1.0, and a melt mark ratio was 18%. Further, d 002 was 0.3364 (nm), Lc was 51 (nm), and La was 102 (nm), as determined by X-ray diffractometry. The observation of the surface of the pitch carbon fiber at a magnification of 400 showed that among 100 pieces of the pitch carbon fiber, 6 pieces had cracking.

### Comparative Example 7

Mesophase pitch comprising an aromatic hydrocarbon and having a mesophase ratio of 100%, a softening temperature of 276° C., and a melt viscosity of 3.2 Pa·s (32 poises) at 340° C. and at a shear rate of 10,000 s⁻¹ was fed at 351° C. and at a capillary flow rate of 0.27 m/s (shear rate: 10,906 s⁻¹) using a nozzle comprising a capillary having a diameter of 0.2 mmφ and a length of 2 mm, while spraying air at 354° C. and at 5,500 m per minute from a slit adjacent to the capillary, to pull the molten mesophase pitch by a melt blowing method, preparing a web comprising a carbon fiber precursor having an average diameter of 13 μm. A melt viscosity in the capillary evaluated by a capillary rheometer at 351° C. and at 0.27 m/s was 0.8 Pa·s (8 poises). Then, the web comprising the carbon fiber precursor was increased in temperature from 200 to 300° C. in air over 30 minutes to prepare a web comprising an infusibilized fiber. The amount of oxygen deposited onto the infusibilized carbon fiber was 7.6 wt %. Subsequently, the web comprising the infusibilized fiber was calcined in an argon gas atmosphere at from room temperature to 3,000° C. over 5 hours to prepare a web comprising a pitch carbon fiber. The obtained pitch carbon fiber had an average fiber diameter of 9.0 μm and a fiber diameter CV value of 13.5%. The shape of the cross-section of the pitch carbon fiber was substantially a true circle of a random structure, and, with respect to 10 fields of view of the cross-sectional image of the fiber taken by a scanning electron microscope at a magnification of 6,000, an average of the ratio (DL/DS) of a long axis diameter (DL) to a short axis diameter (DS) was 1.0, and a melt mark ratio was 0%. Further, d 002 was 0.3365 (nm), Lc was 38 (nm), and La was 72 (nm), as determined by X-ray diffractometry. The observation of the surface of the pitch carbon fiber at a magnification of 400 showed that among 100 pieces of the pitch carbon fiber, 3 pieces had cracking.

### CONCLUSION

As can be seen from the Examples and Comparative Examples, in the pitch carbon fiber of the invention, the lattice spacing (d 002 value) in the graphite layer as determined by X-ray diffractometry is reduced and the crystallite size (Lc) derived from the thicknesswise direction and the crystallite size (La) derived from the growth direction of the hexagonal net plane as determined by X-ray diffractometry are increased, and thus the pitch carbon fiber is likely to exhibit thermal conduction, achieving high thermal conductivity.

Further, the pitch carbon fiber of the invention achieves a decreased occurrence of cracking along the direction of the fiber axis while exhibiting high graphitizability as mentioned above.

1. A pitch carbon fiber having a melt mark recognized in the fiber corresponding to 60 to less than 100% of the cross-section of the fiber, and having a lattice spacing (d 002 value) of 0.3362 nm or less in the graphite layer and a crystallite size (Lc) of 60 nm or more derived from the thicknesswise direction, as determined by X-ray diffractometry.

2. The pitch carbon fiber according to claim 1, which has a crystallite size (La) of 130 nm or more derived from the growth direction of the hexagonal net plane as determined by X-ray diffractometry.

3. The pitch carbon fiber according to claim 1, wherein when the surface of the fiber is observed by means of a scanning electron microscope at a magnification of 400 with respect to 100 pieces of the pitch carbon fiber, the number of pieces of the pitch carbon fiber having an occurrence of cracking in the surface of the fiber is 5 or less.

4. The pitch carbon fiber according to claim 1, which has a cross-section which is substantially elliptic.

5. A method for producing the pitch carbon fiber according to claim 1, comprising (1) a step for preparing a pitch carbon fiber precursor from mesophase pitch by a melt blowing method, (2) a step for infusibilizing the pitch carbon fiber precursor in an oxidizing gas atmosphere to prepare a pitch infusibilized fiber, and (3) a step for calcining the infusibilized fiber to produce a pitch carbon fiber,
the method being characterized in that, in step (1) for preparing a pitch carbon fiber precursor, the melt viscosity in a spinning pore is more than 1.0 to less than 10 Pa·s (more than 10 to less than 100 poises), the mesophase pitch passing through the spinning pore has a shear rate of more than 6,000 to less than 15,000 s⁻¹, and a gas at 4,000 to 12,000 m/minute, which is heated to a temperature that is the temperature ±20° C. of the pitch passing through the spinning pore, is sprayed to the mesophase pitch near the spinning pore, and being characterized in that, in step (2) for preparing a pitch infusibilized fiber, the amount of oxygen deposited onto the pitch infusibilized fiber is 5.5 to 7.5 wt %.

6. The method for producing the pitch carbon fiber according to claim 5, wherein, in step (1) for preparing a pitch carbon fiber precursor, the pitch carbon fiber precursor has an orientation degree of 83.5% or more as evaluated using X-rays.

7. The method for producing the pitch carbon fiber according to claim 5, characterized in that, in step (1) for preparing a pitch carbon fiber precursor, a heated gas at 5,000 to 8,000 m/minute is sprayed to the mesophase pitch immediately below the spinning pore.
